(19) United States
(12) Patent Application Publication
(10) Pub. No.: US 2006/0282681 A1
(43) Pub. Date: Dec. 14, 2006

(54) Cryptographic configuration control

(76) Inventors: Edward M. Scheidt, McLean, VA (US); C. Jay Wack, Clarksburg, MD (US); Wai Tsang, Falls Church, VA (US); Roger Butler, Centreville, VA (US)

Correspondence Address: IP STRATEGIES, 12 1/2 WALL STREET, SUITE I, ASHEVILLE, NC, 28801, US

(21) Appl. No.: 11/441,793

(22) Filed: May 26, 2006

Related U.S. Application Data
(60) Provisional application No. 60/685,738, filed on May 27, 2005.

(51) Int. Cl. H04K 1/00

(52) U.S. Cl. 713/186

(57) ABSTRACT

A method of providing object security includes selecting an object to secure, selecting at least one criterion for authorization to access the object, generating an authorization profile based on the at least one criterion, generating an encryption key, binding the authorization profile to at least one of the object and the key, and encrypting the object with the encryption key.

### CROSS-REFERENCE TO RELATED APPLICATION

This is related to U.S. Provisional Application for Patent Ser. No. 60/685,738, which was filed on May 27, 2006, and from which priority is claimed.

### BACKGROUND OF THE INVENTION

Keys are an essential part of all encryption schemes. Their management is a critical element of any cryptographic-based security. The true effectiveness of key management is the ability to have keys created, distributed, and maintained without requiring user interaction and without penalizing system performance or costs.

Asymmetric, also called public-key, cryptography has received significant attention in recent years. The public-key method includes separate public encryption and private decryption keys that provide a measure of difficulty in deriving the private key from the public key. Public-key management was developed to establish cryptographic connectivity between two points in a communications channel after which a symmetric cryptogen, such as DES (Data Encryption Standard), was to be executed. Over the years public-key implementations have demonstrated their effectiveness to authenticate between entities. However, public-key methods have not been able to handle successfully the requirements of today's global networks.

Many of the recent public-key implementations allow users to create their own keys. This can leave an organization vulnerable, and in some cases liable, if users leave and fail to identify their private keys. Also, to ensure the integrity of public keys, third party infrastructure designs have been proposed. A Certificate Authority process confirms that a certain public key was issued to a specific user. The exchange of certificates with a third party can have significant impact on the performance of a network.

The public-key process is also associated with high computation times. In many instances, hardware solutions have compensated for these high computational requirements. Since public-key architectures historically have been point-to-point designs, moving to a distributed network with group sharing of information can create higher transmission costs and greater network impact. While public-key management systems work well for point-to-point communications and one-to-one information transfer, they are too time-consuming for a single file placed on a server and decrypted by thousands of users. As the trend toward work groups and complex communications infrastructures continues, the need for a more efficient information and communications key management technology becomes paramount. To ensure the integrity of the encryption process, an operating environment that can be trusted should complement the key management technology.

Shared secret keys used with symmetric key cryptosystems are components of the earliest key management design, which pre-dates public-key management. Early symmetric key designs suffered from the “n-squared” problem since the number of keys required becomes very large and unmanageable as the number of users increase. In addition, these designs did not have effective authentication. Symmetric encryption does have significantly better processing performance than public-key implementations.

### SUMMARY OF THE INVENTION

According to an aspect of the invention, a method of providing object security includes selecting an object to secure, as shown in FIG. 1. At least one criterion is selected for authorization to access the object. An authorization profile is generated based on the at least one criterion. An encryption key is generated. The authorization profile is bound to at least the object and/or the key. The object is encrypted with the encryption key.

A cryptographic hash can be applied to the object prior to encrypting the object.

The criterion or criteria can include a rule and/or a role corresponding to a person authorized to access the object. For example, a criterion can be a role within a domain.

The method can also include decrypting the object by an authorized person with a decryption key corresponding to the encryption key to access the object. For example, the decryption key can be identical to the encryption key. The authorized person can also be required to satisfy the criterion or criteria. The method can also include authenticating the identity of the authorized person prior to decrypting the object. For example, the user can be required to provide at least a knowledge-based input, a possession-based input, and/or a biometric representation. The possession-based input can be bound to the biometric representation. Generating the encryption key can include utilizing at least part of the knowledge-based input, possession-based input, and/or biometric representation as an element of the key. The key can be destroyed on decryption, and later can be recovered.

The object can be, for example, data-at-rest or data-in-transit. Other examples of the object as contemplated by the invention include: a program, an application, a device, a hardware operating mode, a database operation, a communications channel, a data flow path, computing platform BIOS, an operating system core, an operating system driver, operating system privilege level, computing platform scripts, computing platform macros, and an OSI stack.

Encrypting the object with the encryption key can include applying the encryption key to the object according to a symmetric key algorithm.

Data integrity can be provided for the criterion/criteria and/or the authorization profile. For example, data integrity can be provided by electronically signing, or by providing a message authentication code and/or a manipulation detection code.

According to another aspect of the invention, a method of establishing a trusted platform includes exercising object security on the platform as described above, as shown in FIG. 2.

According to another aspect of the invention, a method of controlling a computing operating environment includes exercising object security within the computing environment according as described above, in which case the object is an execution stack, as shown in FIG. 3.

According to another aspect of the invention, a method of enforcing data separation includes nesting a number of objects encrypted according to the method described above, as shown in FIG. 4, in which case at least one criterion selected for authorization to access one of the nested objects can be different from another criterion selected for authorization to access at least another nested object. Decrypting an object encrypted according to this aspect can include selecting a first encrypted object and determining if the first encrypted object is nested within a second object. It is determined if the second object is encrypted. If the second object is not encrypted, the first encrypted object is decrypted by an authorized person, who satisfies the at least one criterion for the respective object, with a decryption key corresponding to the encryption key to access the object. If the second object is encrypted, decryption of the first object is prevented.

### BRIEF DESCRIPTION OF THE DRAWINGS

FIG. 1 is a flow diagram of a method of providing object security.

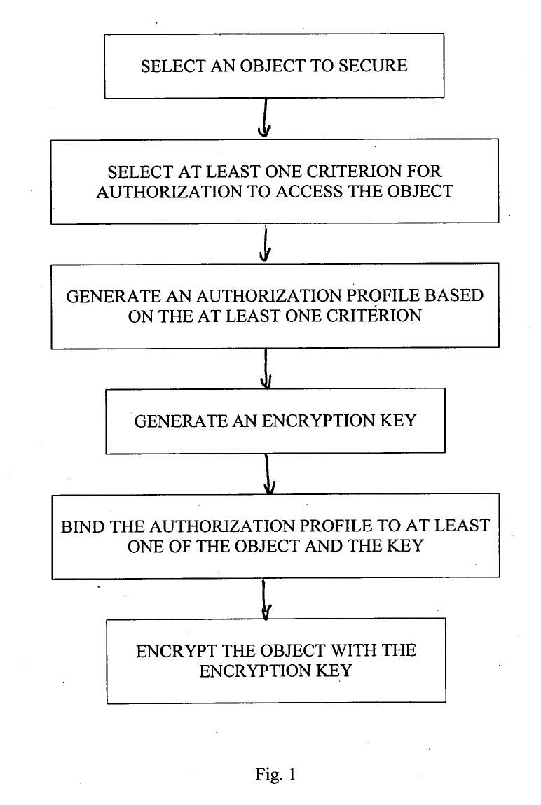

FIG. 2 is a flow diagram of a method of establishing a trusted platform.

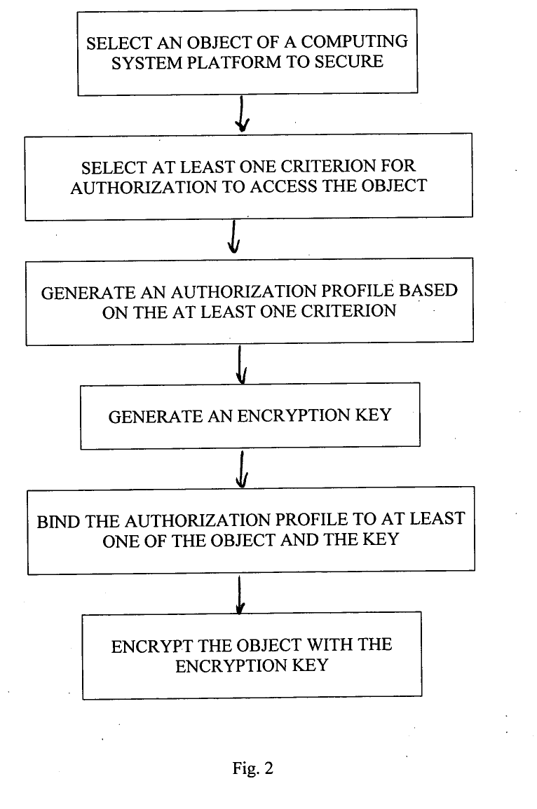

FIG. 3 is a flow diagram of a method of controlling a computing operating environment.

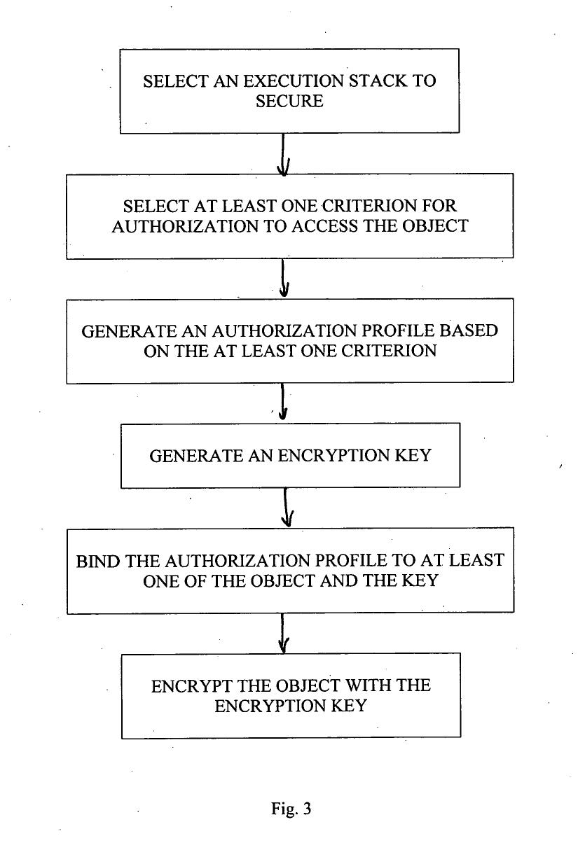

FIG. 4 is a flow diagram of a method of enforcing data separation.

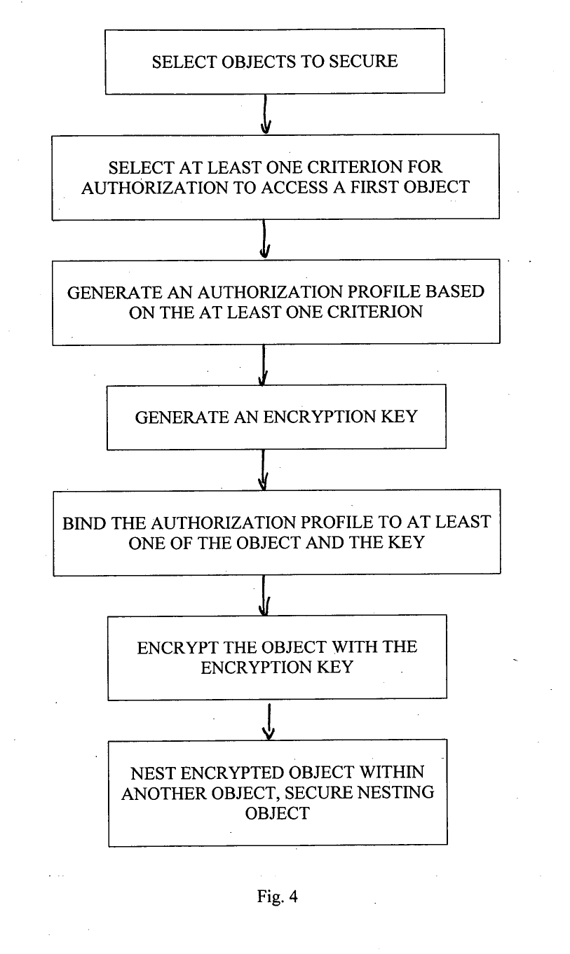

### DETAILED DESCRIPTION OF THE INVENTION

The present invention includes a cryptographic key management system that uses pre-positioned key splits that are based on asymmetrical and symmetrical keys to build a key for encrypting data. The encrypting key is used with a symmetric encryption algorithm. The process is completed when the plaintext data is encrypted. The described architecture provides a complete cryptosystem for today's large distributed networks. The management system of the present invention will be referred to herein as Constructive Key Management, or “CKM”.

CKM builds on the advantages, and takes into account the disadvantages, of both public-key and symmetric key implementations. CKM combines an encryption process based on split key capability with access control credentials and an authentication process based on public-key techniques. CKM is most effective in modern distributive information models where information flow and control are definable, where the information encrypted may need to be recovered, and where authentication using public-key technology and a physical token can be implemented.

This description emphasizes the encryption of data-at-rest as opposed to data-in-transit. Data-at-rest refers to data encrypted as logical units (objects) and includes the creation, processing, transfer, and storage of these objects. Data-in-transit refers to the stream encryption of data moving through a physical or logical communication channel during a certain period of time. CKM can perform both types of encryption. Data-at-rest is described herein for ease of explanation; the described principles also apply to encryption of data-in-transit, but this capability will not necessarily be described explicitly. It is understood that descriptions of the data-at-rest capability extends to data-in-transit.

CKM technology meets several security objectives. For example:

1. Data confidentiality keeps the content of information from being revealed to those who are not authorized to read it. CKM uses symmetric, key cryptography with a robust key management system that provides a new and unique working key for each encryption. The user “selects” the readership or has the readership defined for each encrypted object. An object can be data-at-rest, such as a file or a stored message, or data-in-transit, such as network traffic.

2. Access control restricts use of encrypted objects to those users specifically given permission to use them. Access control in CKM can be role-based, for which permissions are granted and revoked based on that user's responsibility or position within an organization. It encompasses the actions of encryption and decryption but can include permissions to use certain programs, certain devices, or specific hardware operating modes. The concept of access control can also be extended to database applications. Further, access control can also be used in establishing a trusted platform to execute CKM for data encryption and application separation. The computing platform on which the CKM process resides must be free of virus and other threats to the encryption process. The CKM process can also be used to control the computing operating environment through control of the execution stack.

3. Adding credentials during encryption can result in restricting readership within a domain. Adding signing to the credential further ensures integrity of the credential. Access control can be expanded through the use of different symmetric key algorithms while maintaining one set of credentials. The CKM process data header can be decrypted independently of the companion encrypted data object to maintain private communications. The enforcement by the CKM process of the separation of applications and their respective data is a liability shield between two defined application domains.

4. The CKM process can create a multi-level, multimedia security domain by having simultaneous control over the information flow of multiple media formats while allowing for clear data separation. The ability to cryptographically secure objects ensures the authentication and data integrity to the particular object. The CKM process is able to cryptographically control an object(s) or nested object(s) for which an object is contained in another object; the result is total control over the entire object and all other objects within it. This type of control over the information flow is a clear data separation, and with the Execution Stack Modifier would be under the total control of the computing operating environment.

User Authentication establishes the identity of a user (person or device) to the system. User authentication becomes stronger when enhancements such as smart cards and biometrics are provided to complement the CKM process. As well as providing stronger user authentication when used as a token, a smart card can be an excellent hardware platform to implement various levels of CKM technology. The card can be used as a memory-only device, or it can be expanded to include processing capability. An advanced smart card, called the Secure Token can be a component of CKM. Along with its increased processing and memory, the Secure Token includes a unique radio frequency signature and random number generation capability.

Adding biometrics to CKM enhances user authentication and can provide instances of data for generating the private key portion for the asymmetric key cryptographic system that CKM uses for digital signatures. A user can be bound to an identity process and a user profile that results in a private user access.

5. The technique of data separation as it applies to CKM is defined as the ability to keep data in the same domain (i.e., physical, logical, network or information) while still enforcing access controls. Two cryptographic means of separation are used in CKM separation by algorithm and separation by label. User groups can be identified and further separated in an environment through enforcement of role-based access control.

6. Key recovery in CKM is the ability to regenerate the keys used to encrypt objects. Key recovery means that within any particular CKM domain (or organization) encrypted objects are not lost with the loss of any individual. Key recovery for export is included. Key recovery can establish a legal organization response to recovery scenarios.

Asymmetric key cryptography used for digital signatures offers CKM the means to meet three additional security objectives concerned with message authentication:

6. Data origin authentication (sometimes called message authentication) corroborates the source of CKM-encrypted information.

7. Data integrity is the ability to prove that a CKM-encrypted object has not been altered since being encrypted and digitally signed. If digital signatures are not used, a Message Authentication Code (MAC) or Manipulation Detection Code (MDC) with encryption can provide data integrity.

8. Non-repudiation proves that the signature on a signed object came from the signatory such that the signatory cannot deny digitally signing the object.

The basic CKM design focuses on the functions needed for encryption and decryption of objects as well as the distribution and management of keys. High-performance symmetric key cryptographic algorithms and a method of key management are used at this level. A second level, focusing on authentication, uses smart cards and biometrics to create strong entity authentication and uses digital signatures for message authentication. A third level that adds a mix of detection techniques and of operating environment protection techniques for internally protecting the CKM authentication and encryption processes is added when the environment requires more security.

Overview of CKM Technology

CKM is a technology for generating and regenerating cryptographic keys, and managing those keys within an organization. A cryptographic working key is generated immediately before an object is encrypted or decrypted. It is used to initialize a cryptographic algorithm for encryption or decryption. The working key is discarded after use.

The working key is built from many pieces of information. To be a participant in the system, a user must have the pieces necessary to build the key. otherwise encryption and decryption cannot take place. A central authority generates these pieces, which are called cryptographic key splits. A subset of these splits is distributed to each user in the organization. The subset that each user receives is specific to that person and defines which labels that individual may use to encrypt (known as write permission) and which labels that individual may use to decrypt (known as read permission). Several user authentication techniques are used to verify a user to the CKM system before that user is allowed access to this information.

To build a key, a constant system-wide split, called the organization split, and a variable system-wide split, called the maintenance split, are used. To this, a random number, which is called the random split, and user-selected label splits are added. The random split ensures that a unique working key is created for each use. User-selected label splits define the “readership” of the CKM encrypted object, that is, which users will be able to decrypt the object. All of these splits are provided to a process known as the CKM combiner process. The output of the combiner process is a unique number that is used as the basis for the session key.

CKM uses a hierarchical infrastructure to manage the distribution of information necessary for CKM-enabled software to construct cryptographic keys. This infrastructure also provides a method of user certificate and public key distribution for asymmetric key cryptography so that digital signatures can be used. The working key with encryption can be used with the internal operating execution process to protect selected facets of the overall operating process, to ensure 1) that data associated with defined applications is protected against leakage, remains bound to the application, and is protected from unauthorized reading, 2) that defined applications are separated by crypto enforcement so that the management of liability can be realized, and 3) that the CKM process is not altered.

System Hierarchy

CKM is preferably structured as a three-tier hierarchical system. The top tier is a process identified as the Policy Manager. This process enables the “central authority” for the encryption domain to generate splits, which in current implementations of CKM are 512 random bits, to be used by a mathematical combiner or binding process in key generation for encrypting data. Policy elements are established that will be used to create the boundaries for the overall process. In addition to policies, seeds are created for selected encryption components associated with labeling and components to the combiner process.

The next tier in the hierarchy is a process identified as the Credential Manager. This process establishes labels (for example, a matrix of labels), includes specific encryption algorithms, and incorporates policies from the Policy Manager. Individuals are allocated use of specific labels and algorithms from the Credential Manager's subset. Organizational policies, and system parameters generated by the Policy Manager are added to these labels, forming an individual's credentials. A user's credentials are encrypted and distributed to that user on a “token”, such as a diskette or a smart card, or installed on a workstation or server. The process of label and algorithm allocation by the Credential Manager allows an organization to implement a “role-based” or “rule-based” system of access to data and information from a user perspective.

As a convenience to the Credential Managers, password supervisors may securely distribute “first use” passwords to users that will unlock user credentials the first time they are used. In lieu of the password, a smart card or biometric can be used to validate the user.

Access to user credentials is controlled at the user tier of the CKM hierarchy with a password initially assigned by the Credential Manager. The password is changed at the time of first use by the user and is known only to the user. This provides rudimentary user authentication. Stronger authentication is provided by enhancements to CKM, such as a smart card or biometric, as described below.

User authentication enhancements include a smart card—a processor and memory packaged into a plastic card, like a credit card—that can hold pieces of information for user authentication. It can also retain information for use by CKM and provide processing for CKM. A smart card with tamper resistance and hardware random number generation capability offers additional security.

Another authentication enhancement is the use of biometric data. Biometric data is physiological or behavioral information that is unique to each individual and that does not change during that individual's lifetime. Furthermore, it has to be something that can be digitized and used by a computing platform. In addition to strong user authentication, biometric data can be used in the creation of private keys for digital signatures.

For data integrity alone, a Message Authentication Code (MAC) can be used. Instead of the CKM-generated key being used to initialize symmetric key algorithms, a generated key is used to initialize a MAC. Manipulation Detection Codes (MDCs) can also be used to provide data integrity and secrecy when combined with CKM encryption.

If data origin authentication, data integrity, and non-repudiation are required, then the CKM infrastructure is used to provide the means to distribute public keys, which give CKM the ability to use cryptographic-bound digital signatures. If a digital signature is used, MACs or MDCs are not required. Combining digital signatures with the basic CKM design and adding user authentication enhancements establishes the means to meet the security objectives stated above.

Combiner Function and Splits

The CKM combiner is a non-linear function that takes multiple inputs and produces a single integer. The integer output is used as the session key for encrypting and decrypting objects, such as data or information.

The starting point for the combiner function is the domain split. The domain split is included wherever a domain has been established for a defined trusted boundary. Note that CKM is a closed encryption process that is built on trusted relationships. Digital certificates, smart cards, and biometrics all add to enforcing the trust model.

During encryption, a user will choose one or more credential splits to be used in the combiner process. For decryption, the CKM process detects the presence of identified credential pointers in the CKM header to create a transparent operation. This will define the readership of the encrypted object, as only those who have access to splits used for encryption will be able to decrypt the object. The selection and usage of labels by users should be taken into account in designing the label set; label sets should reflect the information data model that is consistent and pervasive within the organization. Good label set design should mirror an organization's established information compartments or desired information control and exchange. Labels can be mapped to roles, rules, or other means of identifying information flow, exchange, and control. It is also possible to specify mandatory-use labels for a specific user or group of users. These correspond to label splits that are always used when the user encrypts an object. The user has no choice in their selection—they are used automatically in the combiner.

A random split, generated for each encryption, is another split that is provided as an input to the combiner function to make the final working key. Because a new random split is generated at each encryption, the working key is always changing. It will not be the same, even if the same object is encrypted again using the same labels. The random number should ideally come from a hardware-based random number generator. However, if appropriate hardware is not available, a software-based pseudo-random number generator can be used.

The maintenance split is used for key updating and compromise scenarios. The organization's policy might require that one of the splits be periodically changed. The maintenance split is changed in order to make an organization-wide impact. The Policy Manager can periodically generate a new maintenance split that is distributed to users via credentials file updates. Generation of the maintenance split is done in such a manner that all the previous maintenance splits can be recovered. Thus, for data-at-rest architectures, previously-encrypted data can be recovered. For data-in-transit architectures, such as encrypted network traffic, there is no need to recover previous maintenance splits.

The maintenance split can be used to exclude someone from the organization domain. If an individual does not have credentials that have been updated with the new maintenance split, then that individual will not be able to decrypt objects that have been encrypted using this new maintenance split. Updating the maintenance split will also protect encrypted data if a user's credentials have been compromised.

In summary, the domain split is a number used in all encryption. The maintenance split is used to maintain a periodic change to the working key's input. The user selects label splits, and the random split is always unique, thus ensuring that every encrypted object has a different integer output.

Cryptographic Algorithms

CKM, with its pre-positioned splits for user credentials, provides one sub-key element to the CKM process that results in a data key that is used with symmetric key cryptographic algorithms. These symmetric encryption algorithms can include DES, AES, or other algorithms, as well as the associated algorithmic modes, that have been designated for encrypting data.

The CKM architecture can be expanded to include other asymmetric key cryptosystems for message authentication, for user credential distribution, and for key exchange through the communications protocol between computing platform and smartcard.

The Policy Manager can name an algorithm and operating mode. Different algorithms can be put to use for different purposes and an algorithm's name can reflect its use. The names of the algorithms that a user has permission to use are contained in the user's credentials. Since the Policy and Credential Managers control access to algorithms, applying different algorithms has the effect of further separating access to encrypted data.

Symmetric key algorithms are used in CKM for encrypting objects. They are also used internally in the CKM combiner process. A biometric reading can provide the basis for a user's private key. If a recoverable biometric process is available, the private key need not be stored since the user can recover it by taking the biometric reading. The public key used for authentication can be derived from this private key and is stored in the user's Credential Manager's database. To base the private key on a biometric reading requires special properties regarding the biometric instance. Normally, these special properties do not apply, in which case the private key will need to be generated separately from the biometric process by the user and stored, usually on a user's computing platform or smartcard. A secure backup is needed for this private key in case of loss. Note that the Credential Manager will not have access to a user's private key used for authentication, if a client-based design is used.

The public-key pair for each user that is used for credential distribution is generated and stored by the Credential Manager. Since these key pairs are used only to encrypt information from the Credential Manager to the user, the private key does not have to remain unknown to the Credential Manager. Thus, the Credential Manager stores both the public and the private keys for its users in its database. User's public keys are used to encrypt the key used to encrypt user credentials for distribution. The Credentials Manager stores user's private keys only for backup purposes. Users must have their own copy of their private key so they can decrypt their credentials when received.

Asymmetric key systems are also used for exchanging a session data key between a CKM-enabled smart card and a computing platform. A public /private key pair is generated by the computing platform and by the smart card for this purpose.

User Permissions

A user credential file includes a user's permission-set, that is, the label splits, their associated label names and indices that can be used for encryption (write permission) and decryption (read permission), and the permissions to algorithms that may be used. When digital signatures are used, a copy of all the organization's Credential Manager's public keys are included, as well as the user's signed certificate.

In assigning a permission set to a user, the Credential Manager looks to that user's role and its related responsibilities and privileges within the organization. Role templates and role hierarchies in the Credential Manager software aid the Credential Manager in this job. An individual's role may change; hence, credentials can be reissued with different labels, or can even be revoked altogether for an individual who has left the organization.

User credentials are preferably encrypted and must be decrypted by each user before use. Decrypting the credential file is the basis for cryptographically identifying the user. The key used for encryption and decryption is derived from the user's ID, as well as from a password that only the user knows. Some unique data, such as a date/time stamp associated with the file, or a random number residing in a place different from that of the credentials file is also used. Every time the credentials file is decrypted for use, it is re-encrypted using different data. Since this data is always changing, the credentials file is encrypted with a different key after every use. This increases the work that an adversary must do to break a user's credentials. Since a piece of information other than a password is used, an adversary must determine this unique data before a password-guessing attack can take place.

When a smart card is used, a random number can be stored on the smart card. This has the effect of tying the user and the smart card to the credentials file. In this case the credentials file cannot be decrypted without the smart card.

When biometrics is used, the biometric representation offers another piece of information from which to derive the credentials file encryption key if the reading, or a corresponding instance, can be reproduced exactly each time. This further ties the user to the credentials file. However, if the biometric representation cannot be reproduced exactly each time it must be statistically compared to a stored baseline template for variance calculation purposes. In this case the template is not used in the encryption of the credentials. Instead, it is used for authentication and is carried in the credentials where it is used to compare to each biometric representation.

The credentials file preferably carries an expiration date. Beyond this date the credentials file is useless. Each CKM encrypted object contains a time stamp in its header. Objects encrypted by others beyond the expiration date of the credentials cannot be decrypted. The maximum time of validity value—the time from credentials issuance to credential expiration—is set by the Policy Manager. A Credential Manager may further restrict the time of validity but cannot extend the time of validity value when issuing credentials to a user. To use CKM after credentials have expired, a user must have credentials reissued by that user's Credential Manager.

Upon enablement of a credentials file, the Credential Manager software generates a new “first-use” password. Before the new credentials can be used for the first time the “first-use” password must be used to decrypt the credentials and then a new password must be provided for subsequent encryption and decryption of credentials.

The “first-use” password is generally transmitted to the user out of band using a different communication channel than that used to transmit the credentials file. An asymmetric key cryptographic algorithm can be used to encrypt a “first-use” key. A private key provided by the Credential Manager is used to recover this “first-use” key and decrypt the credentials.

When biometrics is used in the encryption of the credentials file, the user's public key is contained in the credentials and will be used as a check. Only the correct biometric representation will produce a private key that generates a public key that matches the one in the credentials.

To be able to encrypt, decrypt, sign, and verify objects, a user must have credentials. They provide most of the “secret” information needed for these actions and are tied to a user with strong authentication techniques when the full CKM system is used. A user's access permissions may be revoked by taking away that user's credentials or by allowing them to expire without renewal. If credentials are required to be stored on a central computing platform then a user's credentials can be removed immediately.

Label Set Design

CKM uses encryption to provide selective access and control to information. When encrypting with CKM, users (persons or devices) manually or automatically select labels they share with intended receivers of the information being encrypted. The user may apply as many labels as needed to target a specific subset of information or information grouping. Only users holding credentials including matching labels will be able to view the information. Since there is a logical relationship between labels, such as Boolean AND and Boolean OR, the selection of labels can be broad or narrow in scope, or in a different perspective, a selection of labels can lead to a very granular access to information or to data.

Labels are the humanly-understandable counterparts of CKM's cryptographic splits. They form one of the variable parts of an access control system.

Because of the label architecture, CKM is well-suited for data separation and control of role-based access to information. Data separation is the process of assigning information to multiple levels or categories, and then restricting access to each level based on need-to-know or other security policy. Role-based access control is used to assign access to information based on roles performed, and then to assign individuals to these roles. Each individual's access to information changes as his/her roles change. Rules can be treated like roles in this context.

The Internet employs an open publishing paradigm, which in turn has facilitated the creation of search engines to crawl the Web to discover, mediate, and retrieve information from disparate repositories. The tagging or indexing methodology of these search engines can be correlated to labels that are included in the cryptosystem. An example is the XML that includes a tag for acting on the data; adding the CKM header to the tagging of XML results in an embedded security with XML.

Labels can mirror established information compartments within an organization. For example, if a large organization has identified 500 information compartments, then the CKM Policy Manager would create 500 labels representing these compartments. Specific labels would be assigned to individuals assigned to roles with access to specific compartments. Top-down mandated information compartments simplify the process for individual users. If an individual is assigned to roles within two information compartments, then their CKM credentials only present these two label options for encryption. In practice, however, a total mandated compartment system is not sufficiently flexible. It is best to allow each user some flexibility in designating readership restrictions for material to be sent outside mandated compartments.

Labels also can be used to designate readership across the organization. For example, the label “Personnel Information” can be issued to all persons within the organization. All persons would be able to encrypt information using this label; however, only managers and those persons assigned to the personnel department would be able to decrypt such information. Other “across the organization” labels with similar encrypt and decrypt restrictions might include Security, Legal, Inspector General, or other organizational groups or functions.

The use of templates can aid the distribution of labels. Templates can be made to include labels that represent an organization's information flow boundaries, or to represent a grouping of information subsets. By nesting templates and assigning them to numerous users at the same time, the distribution process is greatly facilitated. For example, a basic role template can be created containing the labels to be assigned to all employees. Additional templates can be created and assigned for supervisors, managers, and executives, or for other roles as required.

Care must be taken to design a label set that is as limited as necessary to meet security requirements. The objective should be to combine labels representing a mandated compartment approach with labels that allow for ad hoc and cross-organizational (compartment) communications. The resulting label set will allow a simple, easy-to-use sub-set to be distributed to each user.

The Header

Every encrypted object includes supplemental data that is referred to as the CKM header. This data is needed to decrypt the object. It contains, as a minimum, an index to the label splits and the algorithm used in the encryption process, the organization name, the maintenance level pointing to the maintenance split to be used, and the random split. The random split is encrypted by using an encryption key based on the same label splits used to encrypt the object. To be able to recover the random split, a user must have read access to the label splits that were used in encrypting the object. The organization split, maintenance split, and label splits that are contained in a user's credentials, along with the random split recovered from the CKM header, allow the encryption key to be recovered. The object may then be decrypted.

Also included in the CKM header is a time stamp indicating the date and time the object was encrypted. CKM will not allow a user with credentials that have expired to decrypt the object.

The ID of the user who encrypted the object, as well as the identity of that user's Credential Manager is contained in the header. If a digital signature is used, it is contained in the header along with the user's certificate. With the appropriate Credential Manager's public key, all of which are contained in each user's credentials, the certificate may be decrypted to recover the signing individual's public key. This public key is used to verify the digital signature once the message is decrypted.

Most of the header itself is encrypted using a constant header split. The intent of using this split is not security. This is a step to discourage anyone from trying to break the system by preventing easy initial success. All information in the header is either public, or in the case of the random split, encrypted within the header. If the header information needs to be protected for security, the key to decrypt the header must be handled as a secret. An option would be to put the header key in selected tokens to further differentiate who had access within a domain or a sub-domain.

Data contained in the header can offer a basis for certain types of information searches and database queries. Search engines could include logic to look at the CKM header to provide data separation. Since the header does not reveal message contents, a CKM header process may be placed on network monitoring and control devices to check traffic for verification, integrity, routing, etc. without revealing the encrypted data. For example, label information contained in the header can be the basis for keeping encrypted data confined to a network domain by effectuating network edge devices to prevent data with particular labels from crossing certain network boundaries. Thus, by using the header, CKM lends itself to managing and encrypting data-in-transit over a network, as well as static data-at-rest.

Data Separation

Data separation is the process of assigning data to and restricting access within an organization according to pre-defined limitations. From a commercial perspective, cryptographically-enforced data separation can be argued for limiting liability among collections of data. Once the data access is defined by the organization, the CKM encryption process enforces the established policy by leveraging permissions that are assigned to the data and reflected in the organizational usage.

The traditional means to separate data is through physically placing data where unauthorized people cannot access it. However, providing physically separate networks or machines to host different sets of data can be cumbersome and costly.

Data separation through CKM can be effective in the computing platform's execution process. Enforcement of the major steps in the execution process can ensure that the computing platform is established as a trusted host for initializing the execution process, for executing applications, for processing application data, and for ensuring the integrity of the overall encryption process. The trusted computing platform is needed to protect the encryption process while, in the background, the encryption process is protecting the computing platform. Once the encryption process is engaged in the host platform process, further security extensions to the network are possible.

Key Recovery

Key recovery in CKM is an organized process to regenerate the encryption key from the existing CKM process, requiring access to the encrypted object. The Policy Manager can initiate a recovery process and provide any Credential Manager with all label splits required. Examining the CKM Header will indicate the components needed by the administrative tool to recover the plaintext information from the encrypted information. The Credential Manager is able to provide credentials with read capability for label splits that were used to encrypt the object.

Because the encryption by CKM is at the object level, only that object can be recovered. Each file or encrypted object would need to be recovered individually.

A reason to use key recovery would be for recovering data encrypted by an employee who has left the organization, died, or who has become incapacitated. Because CKM is enforced through a role- or rule-related relationship to information, a person replacing the departed individual would be able to maintain continuity through a common role or rule.

For a third party to recover data would require access to the administrative capability of CKM.

Lost credentials or a lost password can be recovered through reissuing one or both to the user. The reissuing administrator, if necessary, retains a copy of the original credential and password. To tailor the security of the password to the user, the user may change the new password.

User Authentication Enhancements Strong user authentication should require something that an individual knows, something possessed by the individual, and something that individual is. The most common illustration of the user authentication can be illustrated in the following: Passwords, something known, are used for rudimentary user authentication; smart cards (or other tokens) are something possessed; biometric data is something an individual is. All three can be used in CKM.

Smart Cards Enabled with Biometrics

Smart cards can be used to hold key pieces of data in the CKM process; the card can contain the mathematical combiner to assemble the asymmetric and symmetric keys, or it can contain a portion of the combiner that is used in conjunction with middleware. A random number stored on the card can be used as a piece of data in building the encryption key to encrypt the object. The purpose of the random number is to create a dynamic key for every session or object encryption event. The permissions are used in the CKM combiner to protect the random number while in transit, further binding the credentials to the enforcement mechanism of the combiner. With the combiner or partial combiner action being done on card, the card is also tied to the credentials.

In addition to the CKM process on card, a unique number associated with the card can be used to provide authentication. That number with a password associated with CKM can further bind the card to CKM and the individual. Biometrics can be added to the mix of the card and the password to offer a multi-factor authentication model. If the multi-factor model is employed, any individual authentication capability will not result in completing the identity-authentication process, nor can the CKM process be used. For instance, the smart card alone is not sufficient to start a session, thus defeating an adversary who has stolen or otherwise acquired a user's smart card.

Because user credentials can be stored on the smart card, a user can use other computing devices that have been configured with CKM. The card with the CKM combiner or parts of the CKM combiner and the split keys offers transportability.

Security is enhanced by keeping decrypted user credentials in the smart card's memory only for the duration of a session, as well as by running the CKM combiner process on the smart card's processor. Local processing within the card increases the workload of an adversary who is attempting to view the internal workings of CKM processes in order to gain information about secret keys. An added level of secure assurance can be realized by encrypting the all the components associated with CKM that are on-card; for the added assurance, the key (card key) can be derived from an authentication process or a unique key stored outside of the card.

The Secure Token

The Secure Token is an ISO compliant smart card that has enhanced processing ability and greater memory than current smart cards. It includes tamper resistance and hardware random number generation. The processing capability internal to the card can be used to reduce CKM task processing on the computing platform by including the combiner and keys on-card. Even though the bandwidth between the card and the computing platform is limited, with CKM only small amounts of data are transferred between the two. Larger memory within the card also makes it possible to store user credential files, as well as “private” CKM applications as separate application silos.

To keep “secret” information, such as splits, from being revealed to someone monitoring communications between the card and the computing platform, the communications between the Secure Token and the computing platform is encrypted. The key agreement protocol used to exchange the encryption key is between the card and the computing platform. No additional intelligence is required in the card reader.

An inherently random radio frequency signature; called Resonant Signature-Radio Frequency Identification (RS-RFID), which is provided by tagents embedded within the card, aids tamper resistance. The digital representation of the RS-RFID of the card is contained within a user's credentials file and can be included in the CKM combiner process as one of the credentials. Since the RFID tag pattern is fixed with the card, its representation as a credential can be dynamic and not be stored on card but created when the card is activated. Any tampering with the card will change the RS-RFID of that card. An altered RFID reading results in no further access or card usage. The RFID reading capability can be included in the smart card reader, but not necessarily activated depending on the level of secure assurance that is desired. Random numbers are needed for dynamic object encryption. In the absence of hardware random number generation such as can be derived from a card, CKM can also use a software, pseudo-random number generator. The choice of a hardware or software random or pseudo-random source can be attributed to a desired level of high assurance.

Biometric Data

The result of a biometric event is the creation of a biometric representation (for example, an image or template). The biometric representation becomes a reference point in successive biometric event usage. Image representations can vary by a small amount, whereas template representation is not a good representation for a credential. However, the action of the biometric event either results in a positive indication or a negative indication, and that indication as a positive one can be the source of a credential. The indication becomes a number representing a biometric event. If the user's biometric event such as a match with fingerprints asserts a positive indication, the credential can be used in the CKM process. If a biometric event is proven to create a repeatable number, that number can be used as the credential in lieu of the indicator number.

A biometric event and its associated number or indicator can be used in the authentication process that precedes the CKM process. In this case, the biometric number is one of the multi-factor functions associated with authentication.

A user's private key for digital signatures can be based on a repeatable biometric representation. A user's public key is generated from the private key. The public key is recorded in the user's Credential Manager's user database as part of the enrollment process. In this case, the biometric event number or representation can be used for further authentication through a digital signature. The private and public key resulting from the biometric event number can be recovered by redoing the biometric reading to generate a private key to further generate a public key. Another alternative for using the biometric event number or representation is to store the representation for comparison with subsequent biometric events. The biometric representation would be stored within a user credential file. During user authentication, the credentials file would be decrypted, recovering the biometric template, and then the biometric reading taken for authentication would be compared to the template and a “yes or no” answer would result.

Message Authentication

Message authentication can be achieved through the use of hash functions. The CKM process includes hash functions internally, but for extending integrity to the plaintext data, a separate hash must be utilized. To further protect the hash process itself, a digital signature can be used.

A cryptographic hash is applied to the object's plaintext, that is, before the data is encrypted. If a digital signature is used, the hash value can be encrypted with the user's public key (which has been generated based on the user's biometric reading), resulting in a biometrically-bound digital signature for that object.

Digital signatures can be an option or can be mandatory, depending on Policy Manager requirements.

Digital Signatures

Digital signatures are used to provide data origin authentication, data integrity, and non-repudiation. Digital signatures are managed through a Public Key Infrastructure (PKI). The intent of the infrastructure is to ensure a linkage among the components that make up a PKI architecture. The math associated with a digital signature is based on asymmetrical key schemes and has expanded to include a digital certificate, which is a packaging mechanism for the digital signature. A signature and certificate can be viewed as a static key. The digital signature is a form of electronic signature as defined by law.

The math associated with CKM includes a credential that is based on an asymmetrical key and is expanded into a symmetrical key process to result in a dynamic key. A separate infrastructure associated with the host computing platform for CKM and additional authentication provides the packaging mechanism for CKM. The CKM process and its supporting infrastructure is a form of electronic signature as defined by law.

There are some parallels in the two architectures of PKI and CKM: both use a central authority to administer the digital certificate and credential, respectively.

A CKM credential can also be further authenticated in itself with its own digital certificate. In the CKM process infrastructure, the digital certificate is treated as a separate component from the CKM process; however, a digital certificate can be included in the internal credential protection component. Having the two ways to use the digital certificate offers a means for trading off on performance and application requirements.

The digital certificate for a user (and not the permission, per se) is signed by that user's CKM Credential Manager. Each Credential Manager has its own public and private key. The public keys of the organization's Credential Managers are provided in each user's credentials. The Credential Manager encrypts, that is, signs, a user's ID and public key combination with the Credential Manager's private key. This is a basic user certificate. It may be decrypted only by using the Credential Manager's private key.

A user's certificate is included in that user's assortment of credentials so that it can be sent with CKM objects the user has signed. The recipient of a signed object uses the Credential Manager's private key to decrypt the sender's certificate and recover that user's public key. The recovered sender's public key is then used to verify the sender's digital signatures on the signed object.

Manipulation Detection Codes (MDCs)

If privacy and data integrity without regard to data origin authentication and non-repudiation are desired, an MDC combined with CKM encryption can be used. An MDC is basically an “unkeyed” hash function that is computed from the message. This hash is then appended to the message, and the new message is encrypted, for example, with CKM.

From verification of data integrity, a recipient decrypts the message, separates the hash from the message, computes the MDC of the recovered message, and compares this to the decrypted hash. The message is accepted as authentic if the hash values match.

Message Authentication Codes (MACs)

If only data integrity without regard to privacy is needed, a MAC can be used with CKM. The working key for the MAC is constructed in the same way as that for the key used for encrypting a message for privacy, that is, by using the CKM combiner process with label splits, an organization split, a maintenance split, and a random split.

To verify data integrity the recipient of the MACed message uses the splits associated with the message to rebuild the key for the MAC. A new MAC is then calculated by the recipient and compared to the MAC sent with the message. If the two MACs match, the message is accepted as not having been altered.

For brevity, MDCs and MACs will not be mentioned in the CKM process description that follows.

The CKM Process

Selected processes are described to illustrate how CKM accomplishes its tasks. In the following examples, it is assumed that a smart card such as the Secure Token and biometrics with the ability to generate a fixed biometric value are used.

Session Establishment

Use of the CKM system is contingent on successful logon and execution of the CKM process. Session establishment begins when a CKM-enabled program is run on a user's computing platform that includes a high-assurance execution operating platform adjunct. The computing platform prompts the user to present the logon data: smart card, user biometrics, user ID, and password. An encrypted channel is established between the computing platform and the smart card. The logon data is transferred to the smart card, resulting in an action on the card to generate a key from selected pieces of the logon process that will be used to decrypt the CKM components associated with the combiner use. If the credentials or other components of the combiner reside off-card, they are sent to the card via the encrypted channel. On successful logon, the credentials file and other data associated with the combiner are re-encrypted and stored, and a decrypted copy of all the components is kept in the smart card's memory for use during the session.

Note that three elements are needed to complete logon—a password, a smart card (or token), and biometric representation. Without knowing the password, an adversary needs to guess or search the entire password space. A password with encryption is used, preferably based on the PKCS5 standard, to minimize a password analysis threat. A random number is used in the PKCS5 model. Continually changing these random bits prevents an adversary from bypassing the process by “replaying” past results. Password policies, such as requiring a minimum number of characters in a password, increase security when passwords alone are used for user authentication. A password is preferably stored in middleware to complement a smart card for authentication but not to be accessible if the card is lost. Passwords alone are still considered weak authentication. Smart cards and biometrics are recommended for stronger authentication.

In this example, the smart card must be present to complete logon. The purpose of the card for security is to include coding relationships to the other authentication factors and storing and executing of the CKM process. The card can be one of the elements in a multi-factor authentication model. The card can be architecturally designed to be the only authentication factor or can be part of several factors. If these factors form a basis for a key that encrypts the CKM process and other sensitive elements or components located on card, this keying process binds the user to the credentials and information control. If a radio frequency card authentication (RFCA) technique is used, a credential is identified with a credential created from the unique random number associated with the radio frequency card authentication technique. An implementation with the RFCA can use a RFCA credential on-card for validation, or it can use a RFCA credential in middleware or on a server for validation. Alternatively, the RFCA credential is used for data encryption through the CKM process, then deleted, and recreated during the decryption process to finally decrypt the data. Like the RFCA authentication credential, a repeatable biometric event number can be associated with a credential and used in the same manner as the RFCA. Once logged on, a user will remain logged on as long as a CKM program is actively being used, and while the smart card remains in the card reader. An alternative would be for a proximity smart card to be used for logon. Other mixes of authentication factors need to be examined to determine an optimum use, but, in the case of a proximity card, the card would not remain in a card reader.

Preferably, there is a time-out value, set by the Credential Manager, beyond which if the user does not actively use a CKM process, the CKM session is disabled. The user must then restart the authentication process to activate the CKM process. When a user quits a CKM process and there are no other CKM processes running at that time, the user may log off or continue to stay logged on until the time-out period has lapsed. Within this time-out period, if another CKM-enabled program is invoked the user does not have to log on. If, however, the time-out period has lapsed, the user will have to log on again. During this period when no CKM-enabled program is running, and before the time-out value has expired, the user may run a utility program that will quickly log that user off.

To enhance the security integrity associated with CKM, a final high assurance platform using an expanded CKM can be made an adjunct to a commercial operating system environment. The intent is to affect the execution stack of the operating platform through the enforcing and controlling capability of an expanded CKM so that anomalies can be minimized or eliminated.

An Execution Stack Modifier (ESM) uses encryption to control the process or access to the following functions: BIOS, with its ability to load an operating system and various drivers, load the operating system core and its drivers, signing of selected components such as the Privilege Level such as Ring Zero and Ring One or equivalent in an operating system, remove or control scripts and macros, and controlling the balance of the operating system drivers not controlled under BIOS. With an executable ESM, selected OSI stack such as Level 4 (IP) and Level 7 (application) can be extended to the Network Stack for extended control in the network environment.

With a smart card that contains the authentication and CKM combiner on-card, a user authenticates to the card and to CKM followed by a scripted BIOS start that extracts a CKM data key from card to decrypt selected BIOS functions. Initial steps of decryption would include verify the loading of crypto, relinquish control to boot strapper, release control to boot time driver, and control over basic I/O drivers. The BIOS would call a key from the card to decrypt the local operating system core and drivers and validate the Privilege Level of operating system through a digital signature. The intent is to create a known state for the boot routine, then extend that state to the operating system and local applications. All script and macro files need to be controlled through encryption or removal or modifying the operating system, accordingly. In addition to the execution of CKM through the use of credentials, selected levels in the operating environment stack need to be signed. Signing will further ensure that the specific element has not been altered or replaced; whereas, encrypting with CKM will enforce an element's use. The data-encrypting action will need to be at the kernel level to be most effective. The Execution Stack Modifier can reside within a processing device. The processor hardware needs to be designed to complement the high assurance integrity of the firmware. An optimum use of the ESM microprocessor would be to complement the BIOS chip device and not have an impact on the computing platform. Changes to the operating system for upgrades might cause an impact.

Detection

The intent of detection is to notify certain individuals and to take certain actions whenever events indicative of intrusion, tampering, or failure have taken place. At its simplest, detection is provided with audit of selected events. The minimum events to be audited are determined by the Policy Manager.

Detection can take other forms, such as statistical tests for randomness on generated random numbers. Weak cryptographic key detection can also be performed. These types of alarms would notify or stop a user from continuing with an action that might compromise the security of the system.

An example of another technique is use of monitors that can read CKM headers periodically, or at random, and verify the label sets contained therein against a user's issued labels per the Credential Manager's database. This would aid a security administrator to detect when someone might be trying to gain unauthorized access.

Summary

CKM technology can provide an effective system for encrypting data-at-rest. It can also provide a suitable system for encrypting data-in-transit. CKM can be extended beyond the application protocol level to lower levels, such as level 2 (for example IEEE 802) in the OSI stack for encrypting data. The CKM encryption protocol to establish the session key for the channel can be adapted to the parameters of the communications environment. In summary, CKM is a key generation paradigm that is adaptable to content and network encryption models.

For high assurance conditions, the CKM process needs an additional level of integrity through supplemental control over the operating environment. An Execution Stack Modifier can be added to an existing operating system for extended control over the total execution process.

Server-Based CKM

In recent years, as distributed processing and open architecture have become more prevalent, it became apparent that the idea of defining a point-to-point relationship is overwhelming and nearly impossible. The Internet was designed to afford connectivity; the term “point of presence” was coined because everyone on the Internet is connected to everyone else.

The traditional usage of cryptography has been limited to point to point/box-to-box/user-to-user. Key management has had to address how the secret associated with the key is shared among users. The key can stop at openings into the network or the key can be moved with the data or information as it is shared. The key management problem, the movement of the keys from sender to receiver, becomes more difficult when the objective is to achieve a finer, more precise separation of information. Rather than box-to-box, or point-to-point, where a tunnel or pipe is opened, and all that is sent is protected from outside access, we are now attempting to have access control and confidentiality associated at the object layer. That is, anything that can be named can be differentially encrypted. This injects the point that every exclusive access desired requires a unique key.

The application of CKM allows the fine-grained access control, communities of interest, a new key for every object, and the ability to work on or off the network. All of these attributes are aligned with modern information processing and improve communication and the maintenance of security and confidentiality on an otherwise open network.

The user base is scattered in a heterogeneous network, with all types of connections, including circuit- and packet-based public and private networks, and satellites. The myriad connections and paths available are too numerous to physically identify, much less control.

To be more effective with security, the user must be controlled, not only as to access to information, but controlled as to the functions that can be performed on the information. A unique number associated with a server can be used as a CKM credential to delineate the encryption and decryption of information on that server; the server credential can be included with other credential access selections.

A server-based CKM offers control over the user, but in the mobile environment, that control is minimized if the user is not connected to the network regularly. An extension to the server through the addition of a thin or thick client (depending on how applications are made available) can bridge the control of the server with true mobility. To accomplish this, the configuration of CKM must be partially located at the client site, to limit the actual decrypted access to information to the specific user and to a specific terminal. The credentials, that is, the roles, rules, and permissions assigned to this specific user, as a second component, can be carried by the user in some form of token or smart card. This token is preferable for several reasons; for example, the collection of the authentication elements, the CKM credentials and signing capability, and the CKM process gives the user mobility, and restricts the user from duplicating the security capability. The CKM process is a collection of modules that can be applied at various stages in a computing architecture. An owner of the system can decide, depending on the degree of involvement and the need for immediate control, where to put the last operationally-required module of the CKM system.

If the environment requires rigid control and immediate response, a server is an architecture to use; however, if mobility is included, the architecture needs to consider the role of the client.

Configuration Control

Cryptographic configuration control can be viewed in various ways. The CKM process includes the protection of the data, access to the data, and signing of the data.

Control can be exerted on the computing platform's operating environment to ensure integrity of the overall operating environment. Selected elements of an Execution Stack Modifier can enforce the operating environment to prevent anomalies from occurring. The CKM process provides a key and a respective policy usage for each of the selected elements associated with the Modifier.

Control can be exerted on the access to the applications. Users should be limited to their access privileges through computing applications. A business relationship or a government restriction could limit the need for specific application access. The CKM process provides a key and a respective policy for access to an application.

Control can be exerted on the access of data that is associated with applications. Objects that are associated with data or content can be encrypted with the CKM process.

Control can be exerted through authenticating the user. The CKM process can be applied to the multi-factors associated with establishing the identity and authenticity of the user.

Control can be exerted over a device with the CKM process. Through a selection of a credential, a specific device function can be activated, and for different users for the same device, credentials can be the differentiator.

Control can be exerted through an access-limit publisher-reader environment. Differentiated access to information from a single source such as a net publisher can be executed through the CKM process. A single message or single file can contain multiple, segregated encrypted sub-messages or files that can only be accessed with appropriate credentials—each message can have unique credentials to further separate access by the business paradigm.

We claim:

1. A method of providing object security, comprising:
selecting an object to secure;
selecting at least one criterion for authorization to access the object;
generating an authorization profile based on the at least one criterion;
generating an encryption key;
binding the authorization profile to at least one of the object and the key; and
encrypting the object with the encryption key.

2. The method of claim 1, wherein the at least one criterion includes at least one of a rule and a role corresponding to a person authorized to access the object.

3. The method of claim 2, wherein the at least one criterion is a role within a domain.

4. The method of claim 1, further comprising decrypting the object by an authorized person with a decryption key corresponding to the encryption key to access the object.

5. The method of claim 4, wherein the authorized person satisfies the at least one criterion.

6. The method of claim 5, further comprising authenticating the identity of the authorized person prior to decrypting the object.

7. The method of claim 6, wherein authenticating the identity of the authorized person comprises requiring the user to provide at least one of a knowledge-based input, a possession-based input, and a biometric representation.

8. The method of claim 7, further comprising binding the possession-based input to the biometric representation.

9. The method of claim 7, wherein generating the encryption key includes utilizing at least part of the at least one of a knowledge-based input, a possession-based input, and a biometric representation as an element of the key.

10. The method of claim 4, further comprising destroying the key on decryption.

11. The method of claim 10, further comprising recovering the destroyed key.

12. The method of claim 4, wherein the decryption key is identical to the encryption key.

13. The method of claim 1, wherein the object is one of data-at-rest and data-in-transit.

14. The method of claim 1, wherein the object is one of a program, an application, a device, a hardware operating mode, a database operation, a communications channel, a data flow path, computing platform BIOS, an operating system core, an operating system driver, operating system privilege level, computing platform scripts, computing platform macros, and an OSI stack.

15. A method of establishing a trusted platform, comprising:
exercising object security on a computing system platform according to the method of claim 1.

16. A method of controlling a computing operating environment, comprising:
exercising object security within the computing environment according to the method of claim 1;
wherein the object is an execution stack.

17. The method of claim 1, wherein encrypting the object with the encryption key includes applying the encryption key to the object according to a symmetric key algorithm.

18. A method of enforcing data separation, comprising:
nesting a plurality of objects encrypted according to the method of claim 1;
wherein at least one criterion selected for authorization to access one of the nested objects is different from another criterion selected for authorization to access at least another nested object.

19. The method of decrypting an object encrypted according to the method of claim 18, comprising:
selecting a first encrypted object;
determining if the first encrypted object is nested within a second object;
determining if the second object is encrypted;
decrypting the first encrypted object by an authorized person with a decryption key corresponding to the encryption key to access the object, wherein the authorized person satisfies the at least one criterion for the respective object, if the second object is not encrypted; and
preventing decryption of the first object if the second object is encrypted.

20. The method of claim 1, further comprising providing data integrity for at least one of the at least one criterion and the authorization profile.

21. The method of claim 20, wherein providing data integrity includes electronically signing.

22. The method of claim 20, wherein providing data integrity includes providing at least one of a message authentication code and a manipulation detection code.

23. The method of claim 1, further comprising applying a cryptographic hash to the object prior to encrypting the object.
